(19) United States
(12) Patent Application Publication
(10) Pub. No.: US 2018/0221836 A1
(43) Pub. Date: Aug. 9, 2018

(54) Beverage Bottle

(71) Applicant: Shanghai Yuhao Household Appliance Manufacturing C, Shanghai (CN)

(72) Inventor: Zhenming Ni, Shanghai (CN)

(21) Appl. No.: 15/461,456

(22) Filed: Mar. 16, 2017

(30) Foreign Application Priority Data
Feb. 7, 2017 (CN) 201720114548.8

(51) Int. Cl. B01F 13/00; A47G 19/22; B65D 41/02; B65D 47/06; B65D 43/22; B65D 25/30; B01F 7/20; B01F 13/10; B01F 15/00; B02C 18/12; B02C 18/24; B02C 25/00

(52) U.S. Cl. CPC B01F 13/0022; B01F 2215/0022; B65D 41/02; B65D 47/06; B65D 43/22; B65D 25/30; B01F 7/20; B01F 13/1041; B01F 15/00538; B01F 15/00779; B02C 18/12; B02C 18/24; B02C 25/00; B65D 2525/283; B01F 2013/108; B01F 2015/00597; A47G 19/2205

(57) ABSTRACT

A beverage bottle includes a bottle body, a bottle lid and a cutting device, wherein the bottle body has a side wall and a bottle bottom disposed at the side wall, wherein the cutting device is provided at the bottle bottom of the bottle body.

### CROSS REFERENCE OF RELATED APPLICATION

This is a non-provisional application that claims priority to China application, application number CN201720114548.8, filed Feb. 7, 2017.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a bottle, and more particularly to a beverage bottle capable of producing a liquid beverage.

### Description of Related Arts

Health has been given widespread attention. Water is the source of life. Drinking water is something that people have to do in everyday life. It is a desire to developing more and better water bottles, for example beverage bottles, to facilitate consumer drinking water and helping consumers to protect their health.

The “water bottle” according to the present invention can be used for drinking water by the consumer. It is worth mentioning that the “drinking water” is not limited to drinking water, but also includes drinking fruit juice, tea, milk, soy milk and a variety of drinks mixed with water and other drinks.

A conventional beverage bottle only has the effect of accommodating drinks and facilitating consumer drinking. When the consumer needs to add some food supplements, such as walnut powder, soy milk powder, protein powder, etc., into water to be used to increase nutrition and improve the taste, the conventional bottle cannot make the food supplement be fully mixed with water. If a user wants to ensure it is fully mixed with water, the user needs to use some external force and tools, such as stirring with a stirring rod. This practice is time consuming, laborious, and the stir rod is not easy and troublesome to carry too.

In addition to the drinks formed by mixing with a solid or powder substance with water, the juice extracted from fresh fruit is also popular to the consumers, but the harvest of this freshly squeezed fruit juice is not easy. The household juice machine is undoubtedly a favorite household appliance for squeezing juice, but it is usually bulky, difficult to carry, and the amount of juice extracted is large at a time. When the number of people to drink juice is small, the squeezed juice will be too much and likely wasted when it cannot be completely consumed. In addition, the juicer is not easy to carry so that the consumers cannot get fruit juice drinks anytime, anywhere, so the juice drink access is still not very convenient.

In addition, both the juicer and the juice bottle need to be cleaned after they are used. Making juice by the juicer and drinking juice with the juice bottle, which mean that the consumer will have to clean both the juicer and the juice bottle. It is very troublesome. This is also one of the reasons that many consumers infrequently use the juicer after buying it.

Applicants are committed to providing more convenience for consumers who need beverage bottles and improving the quality of the beverage bottles.

### SUMMARY OF THE PRESENT INVENTION

The main object of the present invention is to provide a bottle, wherein the water bottle is convenient and safe to use.

Another object of the present invention is to provide a bottle which is adapted for making liquid beverages.

Another object of the present invention is to provide a bottle which is convenient for making fresh squeezed fruit juices.

Another object of the present invention is to provide a bottle which is convenient for making an appropriate amount of fruit juice.

Another object of the present invention is to provide a bottle which is convenient for making a variety of liquid beverages.

Another object of the present invention is to provide a bottle which integrates two functions of stirring and squeezing.

Another object of the present invention is to provide a bottle which integrates two functions of smashing and mixing.

Another object of the present invention is to provide a bottle, which comprises at least one beverage making element, wherein the beverage making element is extended and received in a receiving cavity such that, when the bottle body and the beverage making element of the water bottle are separated from each other, the beverage making element does not be exposed and cause injuries to the person.

Another object of the present invention is to provide a bottle, which comprises at least one beverage making element, wherein the beverage making element is extended and received in a receiving cavity such that, when the bottle body and the beverage making element of the water bottle are separated from each other, the beverage making element does not be exposed and damaged.

Another object of the present invention is to provide a bottle, which comprises at least one beverage making element, wherein the beverage making element is extended and received in a receiving cavity such that, when the bottle body and the beverage making element of the water bottle are separated from each other, the beverage making element does not be exposed and contaminated by its external environment pollution.

Another object of the present invention is to provide a bottle, which comprises at least one cutter, wherein the cutter is disposed within a receiving cavity thereof such that, when the bottle body and the beverage making element of the water bottle are separated from each other, the cutter does not be exposed and cause injuries to the person or other items.

Another object of the present invention is to provide a bottle which is easy to carry, so as to facilitate the consumer to drink a liquid beverage.

Another object of the present invention is to provide a bottle which is easy to carry, so as to facilitate the consumer to drink a fresh squeezed juice.

Another object of the present invention is to provide a bottle which is convenient to use, so as to make the consumer easily obtain a liquid beverage.

Another object of the present invention is to provide a bottle which integrates the functions of preparing beverage, accommodating of beverage and consuming for a user, so it is convenient to use.

Another object of the present invention is to provide a bottle, which is capable of preparing beverage and allowing a user to drink or eat the beverage through the water bottle such that the consumer does not need additional container for drinking the beverage. And the cleaning work is also relatively simple.

Another object of the present invention is to provide a bottle, which can enable the consumer easily obtain the desired beverage, so as to facilitate the consumer to supplement the moisture and other energy substances.

Additional advantages and features of the invention will become apparent from the description which follows, and may be realized by means of the instrumentalities and combinations particular point out in the appended claims.

According to the present invention, the foregoing and other objects and advantages are attained by a bottle, which comprises at least one bottle body and at least one beverage making assembly. The bottle body has a receiving cavity provided therein. The beverage making assembly is extended and received in the receiving cavity to produce a producing a beverage for drinking by processing the raw beverage material in the receiving cavity.

According to the preferred embodiments of the present invention, the beverage making assembly comprises at least one beverage making element and at least one driving element. The driving element is used for driving the beverage making element, so as to rotate the beverage making element, and then mixing the raw beverage material in the receiving cavity to prepare a drink for drinking.

According to the preferred embodiments of the present invention, the beverage making assembly comprises at least one beverage making element and at least one driving element. The driving element is used for driving the beverage making element, so as to rotate the beverage making element, and then smashing the raw beverage material in the receiving cavity to prepare a drink for drinking.

According to the preferred embodiments of the present invention, the beverage making assembly comprises at least one beverage making element and at least one driving element. The driving element is used for driving the beverage making element, so as to rotate the beverage making element, and then smashing the raw beverage material in the receiving cavity and mixing to prepare a drink for drinking.

According to the preferred embodiments of the present invention, the driving element comprises at least one energy supplying element and at least one driven element. The energy supplying element provides energy to the driven element to cause the driven element to move, so as to drive the beverage making element to rotate. The beverage making element is fixed at the bottle body to form a firm connecting structure.

According to the preferred embodiments of the present invention, the beverage making assembly is detachably attached to the bottom of the beverage bottle so that the driving element of the beverage making assembly can be separated from the bottle body. The beverage making assembly is fixedly connected to the bottle body when the driving element is separated from the bottle body.

According to the preferred embodiments of the present invention, the bottle comprises at least one bottle body and at least one bottle lid. The bottle body defines the receiving cavity therein and has an opening. The bottle lid is adapted to be used for closing the opening. The bottle lid provides a handle hole.

According to the preferred embodiments of the present invention, the bottle lid comprises an opening cap and a drinking cap. The opening cap is provided at the bottle body. The opening cap has a drinking opening. The drinking cap is used to close the drinking opening.

According to the preferred embodiments of the present invention, the beverage making element comprises a plurality of cutters. The cutters are fixed within the receiving cavity.

According to the preferred embodiments of the present invention, the bottle body has a through hole. The through hole is provided at the bottom of the bottle body. The beverage making element further comprises at least one drive connecting member. The cutters are radially and outwardly extended from the drive connecting member. The drive connecting member is extended to the through hole and closes the through hole. The cutter can be driven to rotate within the receiving cavity by the driving element.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a beverage bottle according to a first preferred embodiment of the present invention.

FIG. 2 is another perspective view of the beverage bottle according to the above first preferred embodiment of the present invention.

FIG. 3A is an exploded view of the beverage bottle according to the above first preferred embodiment of the present invention.

FIG. 3B illustrates a control unit of the beverage bottle according to the above first preferred embodiment of the present invention.

FIG. 4 is another perspective view of the beverage bottle according to the above first preferred embodiment of the present invention.

FIG. 5 is a cross sectional view of the beverage bottle according to the above first preferred embodiment of the present invention.

FIG. 6 is a cross sectional view of a receiving cavity of a bottle body of the beverage bottle according to the above first preferred embodiment of the present invention.

FIG. 7 is a perspective view of a beverage bottle according to a second preferred embodiment of the present invention.

FIG. 8 is a cross sectional view of the beverage bottle according to the above second preferred embodiment of the present invention.

FIG. 9 is an application schematic of the beverage bottle according to the above second preferred embodiment of the present invention.

FIG. 10 illustrates a control system for the beverage bottle according to the above second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

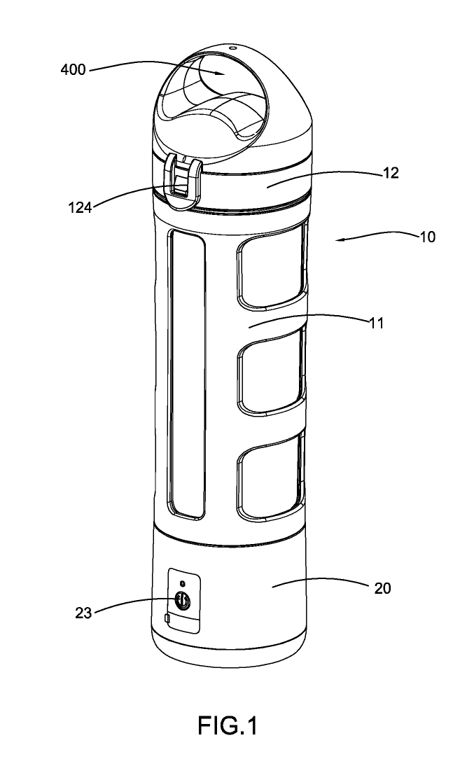

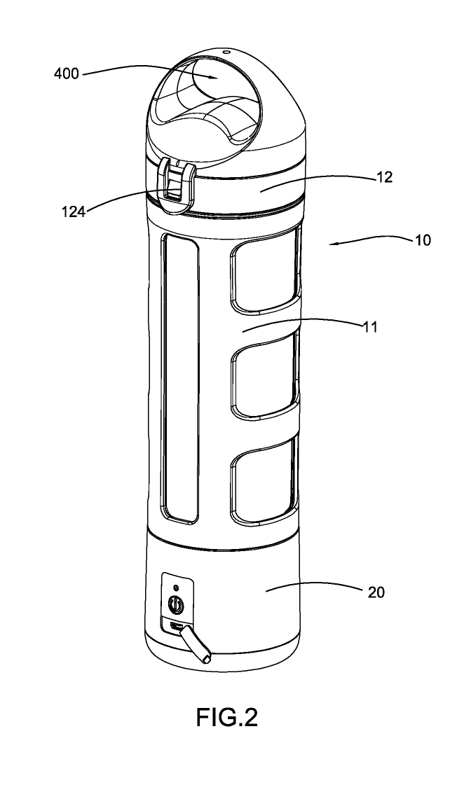

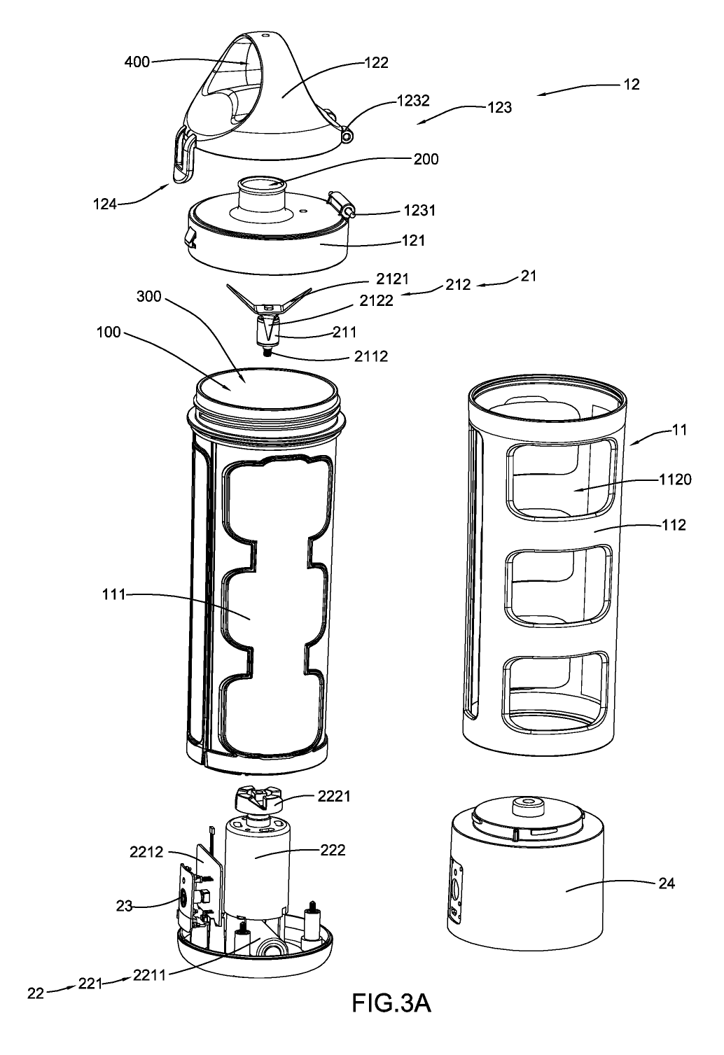

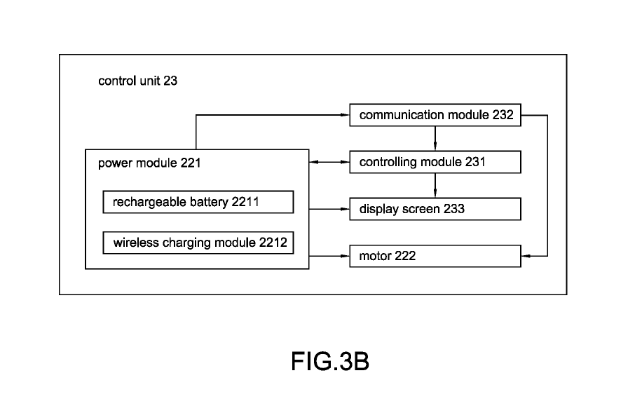

Referring to FIGS. 1 to 5 of the accompanying drawings, a beverage bottle according to a first preferred embodiment of the present invention is illustrated. As shown in FIG. 1, the beverage bottle includes a bottle body 10 and a beverage making assembly 20. As shown in FIG. 3A, the bottle body 10 defines a receiving cavity 100 therein for receiving a beverage. The beverage making assembly 20 includes a beverage making element 21 and a driving unit 22. The driving unit 22 is used to drive beverage making element 21. It is understood by those skilled in the art that the water bottles so called in the invention are not limited to contain water and can be used to contain a variety of beverages, including water, juice and alcohol.

According to the first preferred embodiment of the present invention, the beverage making element 21 is provided in the receiving cavity 100 to achieve the beverage making function in the receiving cavity 100, for example to smash and/or mix the raw beverage materials within the receiving cavity 100. According to the first preferred embodiment of the present invention, the beverage making element 21 can be designed to have a corresponding shape depending on the requirement, so as to serve different beverage making functions and be used for making different beverage raw materials into different beverages. For example, the beverage making element 21 has a solid-liquid mixing function so that a solid substance can be in powder form and mixed with a liquid substance to form a liquid beverage for drinking. For example, mixing solid nutrients, for example, protein powder, soy milk powder, walnut powder and other solid nutrients with water. For example, when the solid nutrient and the liquid such as milk, soy milk and the like are simultaneously placed in the receiving cavity 100 of the bottle body 10, the beverage making assembly 20 may also mix the solid nutrient substances in milk and soy milk for consumers to drink. Consumers can choose the material to be mixed according to their own preferences or needs, so as to deploy their favorite drinks. The present invention is not limited in this respect.

The beverage making element 21 may also be configured to be capable of smashing a larger, e.g., bulk solid material, and mixing it with the liquid in the receiving cavity 100. For example, when the banana and milk are simultaneously accommodated in the receiving cavity 100, the beverage making element 21 of the beverage making assembly 20 can be driven to smash the banana by the driving unit 22 and mix the smashed banana and the milk in the receiving cavity, so as to make the banana milk drink for drinking.

It is understood by those skilled in the art that, the solid material may also have moisture, such as grapefruit, peaches, pears, kiwi, oranges in fruits, which are solid materials and rich in water, according to this first preferred embodiment of the present invention. The fresh juices made of fruits are rich in nutrients, beneficial to the human body, and taste better, so popular with consumers. The water bottle according to the first preferred embodiment of the present invention may also be used to make freshly squeezed fruit juices. It is worth mentioning that, when the juices are prepared, the juices from smashed fruits can be mixed with other liquids, for example, water, to make fresh fruit juices, or the fruits are completely smashed to directly prepare the fresh juices to get liquid fruit juice drinks.

According to the first preferred embodiment of the present invention, the beverage making element 21 is driven by the driving unit 22 to rotate in the receiving cavity 100 around a rotation axis so as to exert the pulverization and/or mixing action by rotation. This arrangement that the beverage production function is achieved by the rotation of the beverage making element 21 has the advantages of simple structure and good mixing effect. According to the first preferred embodiment of the present invention, the driving unit 22 is capable of driving the beverage making element 21 to rotate at a high speed, so that the beverage is produced with high efficiency, so that the consumer can more easily and quickly obtain the drink which he or she needs.

According to the first preferred embodiment of the present invention, the driving unit 22 drives the beverage making element 21 in an electrically driven manner so that the beverage making element 21 can be driven to rotate at a high frequency, so as to achieve the high-speed rotation of the beverage making element 21 and a high and good production efficiency. Comparing with manually shaking to mix, it is also more time-saving and effort.

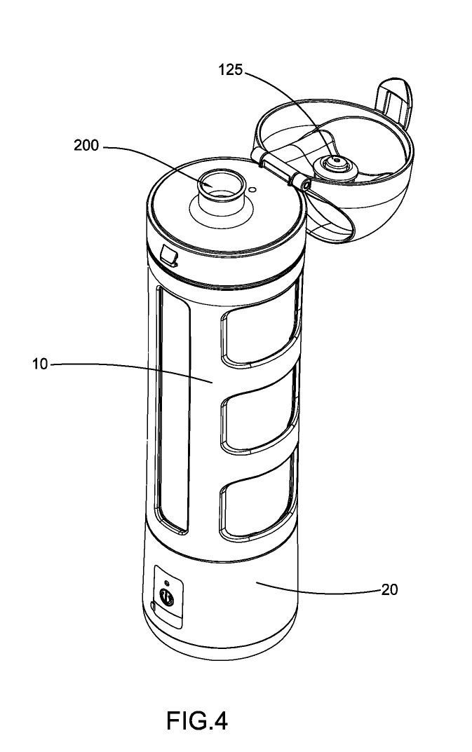

In particular, the driving unit 22 includes an energy supplying element 221 and a driving element 222. The energy supplying element 221 is provided to provide energy to the driving element 222. The driving element 222 receives the energy supplied from the energy supplying element 221 so as to move in accordance with a predetermined movement mode, so as to drive the beverage making element 21 to perform a rotational movement and further perform a rotational movement in the receiving cavity 100 such that the beverage making element 21 can drive the beverage in the receiving cavity 100 to rotate the raw material, and then make the raw beverage material be mixed. According to the first preferred embodiment of the present invention, the beverage making element 21 is capable of not only mixing the raw beverage material, but also capable of smashing raw materials, such as banana, apples, chestnuts and avocado, and mix them into a liquid beverage. According to the first preferred embodiment of the present invention, the beverage making element 21 can also process raw materials having a higher content of liquid ingredients, such as oranges, lemons, oranges, grapefruit, apples, pears and peaches to obtain juices for consumption by consumers. It is worth mentioning that when consumers drink these squeezed drinks, they can either choose to drink the squeezed juices, such as fruit juice, or to drink the mixture of the squeezed juice and its solid crushed. When the consumer chooses to drink the extracted juice, the solid matter can be precipitated at the bottom of the receiving cavity 100 by simply precipitating the extract. At this time, the consumer can drink its liquid crushed material, i.e., the extracted juice, from the top of the receiving cavity. More specifically, as shown in FIGS. 3A and 4, the beverage bottle has a drinking outlet 200 and an opening 300. The drinking outlet 200 is configured to be communicated with the receiving cavity 100 so that the consumer can drink the beverage within the receiving cavity 100 through the drinking outlet 200. The opening 300 is configured to be communicated with the receiving cavity 100 so that the raw beverage material can be placed in the receiving cavity 100 through the opening 300. It is to be noted that the drinking opening 200 is provided for consumers to drink the beverage only as an example of its use of the function and not as a limitation, does not mean that the drinking outlet 200 cannot be used for other purposes. In some application examples, the drinking outlet 200 may also be used for other purposes, for example, for the manufacture of raw materials such as water, milk, and fruit pieces. Likewise, the opening 300 is provided for placing the beverage into the raw material and is merely an example of its function and not limitation. In some application examples, the opening 300 may also be used for other purposes, such as for the consumer to drink the beverage within the receiving cavity 100. The present invention is not limited in this respect as long as it is possible to achieve the object of the present invention.

As shown in FIG. 3A, the bottle body 10 has a side wall 11 and includes a bottle lid 12. The opening 300 is formed in the side wall 11. The drinking outlet 200 is formed in the bottle lid 12. Specifically, as shown in FIG. 3A, the bottle lid 12 includes an opening cap 121 and a drinking cap 122. T he opening cap 121 is provided to be covered with the opening 300. It is worth mentioning that the drinking opening 200 is provided in the opening cap 121. The drinking cap 122 is provided on the opening cap 121 to close the drinking opening 200 when necessary. The opening cap 121 closes the opening 300 when necessary. At the same time, the drinking cap 122 closes the drinking outlet 200 so that the beverage bottle forms a closed structure to prevent leakage of the beverage in the receiving cavity 100 and prevent contaminants from entering the receiving cavity 100.

According to the first preferred embodiment of the present invention, the bottle lid 12 further comprises a sealing member 125 provided in the drinking opening cap 122. The position of the sealing member 125 on the drinking cap 122 is adapted to the position of the drinking opening 200 to enhance the sealing effect of the drinking opening cap 122 to the drinking opening 200.

According to the first preferred embodiment of the present invention, the opening cap 121 is connected with the bottle body in a threaded manner. The drinking cap 122 and the opening cap 121 are connected by a rotary shaft connecting assembly 123. The rotary shaft connecting assembly 123 includes a shaft 1231 and a shaft rotation member 1232. The shaft rotation member 1232 is capped to the shaft 1231 so that the shaft rotation member 1232 is rotatable about the shaft 1231. The shaft 1231 is integrally formed with the opening cap 121. As shown in FIG. The shaft adapter element 1232 is integrally formed on the drinking opening cap 122 so that the drinking cap 122 can rotate about the shaft 1231 so as to flip relative to the opening cap 121, and the drinking opening 200 can be moved between an open state and one closed state transition. As shown in FIGS. 1 to 4, the bottle lid 12 further includes a lock assembly 124 to lock the drinking cap 122 at the opening cap 121, so as to ensure that the drinking opening 200 to be at its closed state. Therefore, the beverage bottle can be placed in a bag without leakage of the beverage within the receiving cavity 100.

As shown in FIGS. 1 to 4, the beverage bottle further has a handle hole 400 to facilitate the beverage bottle to be carried, and the beverage bottle is conveniently carried. According to the first preferred embodiment of the present invention, the handle hole 400 is formed in the drinking cap 122 of the bottle lid 12. The side wall 11 includes a receiving portion 111 and a reinforcing portion 112. The receiving cavity 100 is formed in the receiving portion 111. The reinforcing portion 112 is firmly provided on the outer side of the receiving portion 111 so as to serve as a structure for reinforcing the side wall 11. It is appreciated by those skilled in the art that the reinforcing portion 112 may also be further provided with other functions, such as anti-blistering functions. The present invention is not limited in this respect as long as it is possible to achieve the object of the present invention.

According to the first preferred embodiment of the present invention, the receiving portion 111 is made of transparent material. The reinforcing portion 112 may be designed to have a preset color as desired. The reinforcing portion 112 has at least one window 1120 so that the beverage and its amount within the receiving cavity 100 can be observed.

It is worth mentioning that the side wall 11 plays an auxiliary role when the beverage making element 21 exerts its beverage making function. It is possible that the beverage making element 21 can play a mixing and/or pulverizing action within the receiving cavity 100 because the side wall 11 holds the raw beverage material in the receiving cavity 100. Further, the beverage making assembly 20 is provided at the bottom of the bottle body 10. The beverage making element 21 is placed at the bottom of the receiving cavity 100 which is subjected to gravity when the raw beverage material is placed in the receiving cavity 100, which is deposited at the bottom of the receiving cavity 100 to contact with the beverage making element 21 to form a beverage.

As shown in FIG. 3A, the beverage making assembly 20 further includes a control unit 23 for controlling the operation of the driving unit 22, thereby controlling the rotation of the beverage making element 21 and the production of the beverage.

It is worth mentioning that the energy supplying element 221 may store energy or may be supplemented with energy so that the beverage may be produced by means of the electrical energy provided by the energy supplying element 221 in the absence of an external power supply device. Hence, the consumer only needs carrying the beverage bottle, and the energy supplying element 221 stores sufficient energy, and he/she can easily make the beverage through the beverage bottle, so that he/she can conveniently and quickly obtain the beverage.

As shown in FIG. 3A, the beverage making assembly 20 further comprises a housing 24. The housing 24 is provided on the outside of the driving unit 22 to protect the driving unit 22. A portion of the driving unit 22 is extended to the outside of the housing 24 to be connected to the beverage making element 21 so that the driving unit 22 can drive the beverage making element 21 to move and then be used to make the beverage.

According to the first preferred embodiment of the present invention, the beverage making assembly 20 is detachably connected to the bottle body 10, so as to facilitate detaching and replacing. According to the first preferred embodiment of the present invention, the beverage making assembly 20 is detachably connected to the bottle body 10 in such a manner as to be rotatably connected by a snap. It will be understood by those skilled in the art that the above-described joining method is merely illustrative and not restrictive of the present invention. The present invention is not limited in this respect as long as it is possible to achieve the object of the present invention.

It is worth mentioning that when the beverage making assembly 20 is detached from the bottle body 10, the beverage making element 21 of the beverage making assembly 20 may not be separated from the bottle body 10, but is fixed to the bottle body 10 to avoid damage to the outer object and to prevent the beverage making element 21 from being contaminated and damaged by the external environment.

According to the first preferred embodiment of the present invention, the beverage making element 21 comprises a driving connecting member 211 and a plurality of cutters 212. The drive connecting member 211 is connected to the driving element. The cutter 212 radially extends from the drive connecting member 211. The cutter 212 is provided so that the beverage making element 21 has a good pulverizing function, and the beverage bottle can be used to make freshly squeezed fruit juice.

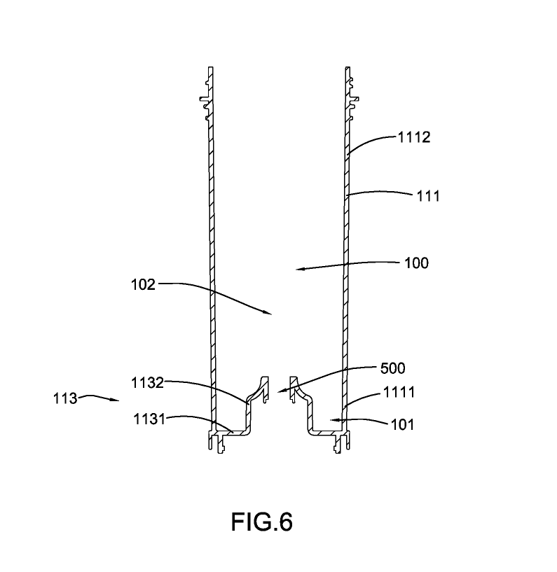

FIG. 6 is a cross-sectional view of the receiving portion 111 of the beverage bottle according to the first preferred embodiment of the present invention. The bottle body 10 has a through hole 500 communicating with the receiving cavity 100 for allowing the drive connecting member 211 of the beverage making element 21 to pass therethrough so that the driving connecting member 211 is connected to the driving unit 22, and the cutter 212 connected to the drive connecting member 211 is provided within the receiving cavity 100.

It is worth mentioning that when the drive connecting member 211 can pass through the through hole 500, the through hole 500 is sealed to prevent the beverage in the receiving cavity 100 leaking from passing through the through hole 500, according to the first preferred embodiment. Specifically, a metal member such as a copper ring and a sealing ring may be provided between the drive connecting member 211 and the beverage bottle portion around the through hole 500 to achieve a rotatable seal connection. It is understood by those skilled in the art that the rotatable sealing manner is merely an example of the present invention and not limitation. It may also be implemented in other ways according to other embodiments of the present invention. The present invention is not limited in this respect as long as it is possible to achieve the object of the present invention.

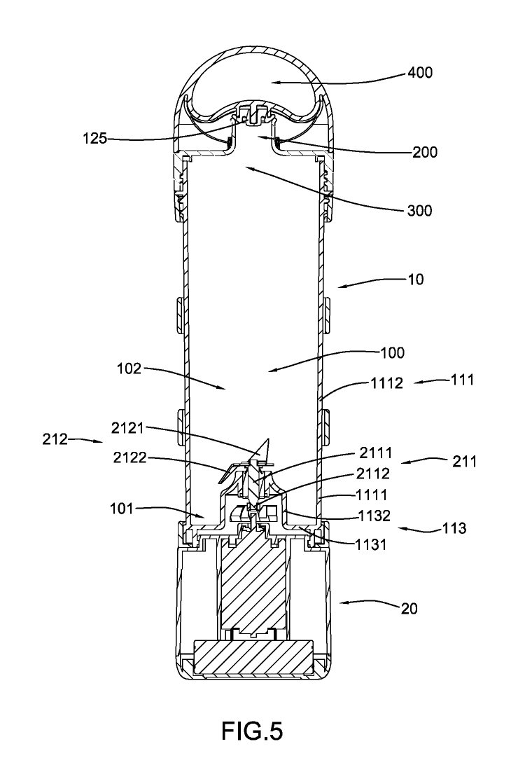

As shown in FIG. 5, the cutter 212 is disposed within the receiving cavity 100, and when the bottle body 10 is detached from the beverage making assembly 20, the cutter 212 can be held within the receiving cavity 100 so as not to be exposed and injury the human body or other objects, but also to avoid its external environment pollution and damage. More specifically, the drive connecting member 211 is fixed to the through hole 500 to fix the cutter 212 in the receiving cavity 100 so that, when the upper and lower portions of the beverage bottle are separated, the cutter 212 is not exposed to the external environment, thereby avoiding its injury to the human body, such as cutting the human finger, according to the first preferred embodiment of the present invention. In addition, it is also possible to prevent the cutter 212 from being contaminated and damaged by the external environment.

It should be understood by those skilled in the art that the above-described structure of the beverage making element 21 is merely illustrative of the present invention and is not limited thereto. The beverage making element may also be provided with other structures, according to other embodiments of the present invention. The present invention is not limited in this respect as long as the object of the present invention can be achieved.

According to the first preferred embodiment of the present invention, the beverage is made in the receiving cavity 100 and the consumer can drink directly through the drinking opening 200 of the bottle body 20 without using other juice beverage bottles to drink very convenient.

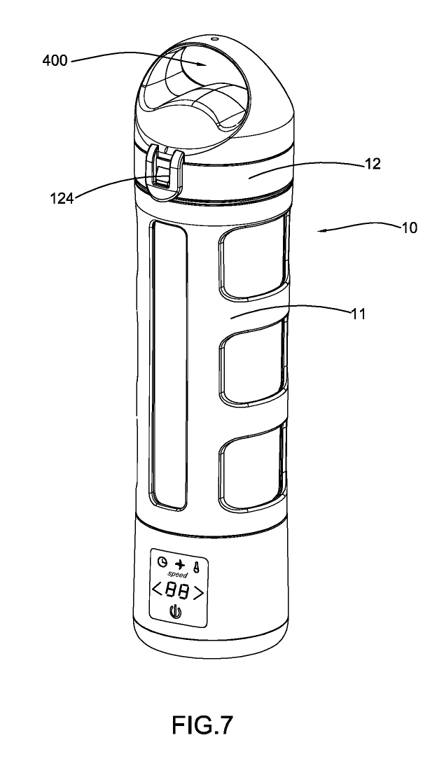

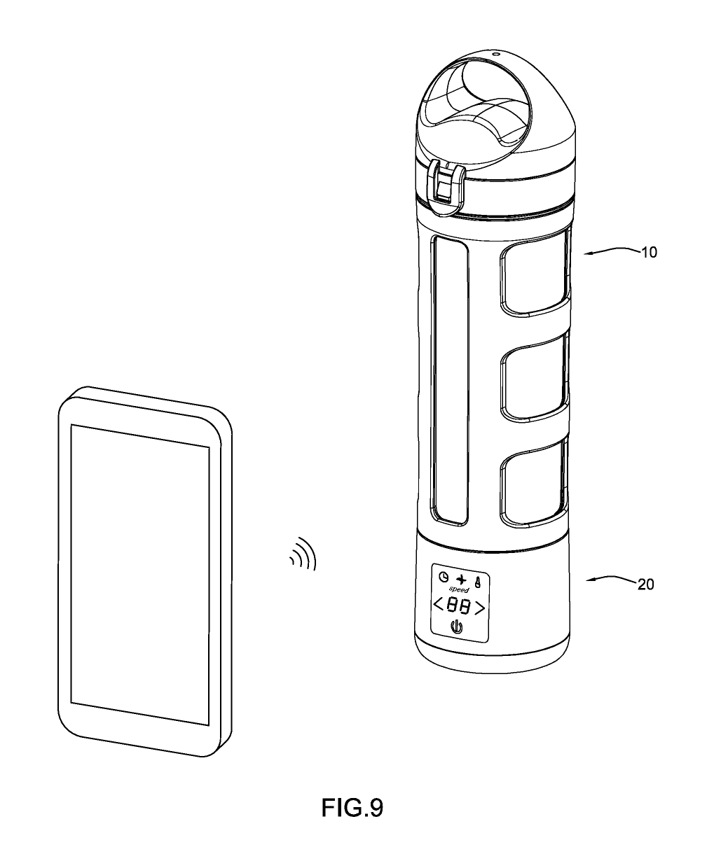

FIGS. 7 to 10 illustrate a beverage bottle according to a second preferred embodiment of the present invention. The beverage bottle comprises a bottle body 10 and a beverage making assembly 20A. The beverage making assembly 20A includes a beverage making element 21, a driving unit 22, a control unit 23A and a housing 24. The control unit 23A includes a touch element 231A and a control system 232A. Being different from the first preferred embodiment described above, the beverage making assembly 20A also has a screen displaying function and a touch function. Specifically, the touch element 231A is embodied as a touch screen, which has not only the function of displaying information, but also can be used as a control panel for controlling the beverage making parameters, according to this second preferred embodiment of the present invention. More specifically, the touch element 231A can be used to display the temperature of the beverage in the bottle body 10, the information, such as the rotate speed and the running time of the beverage making element 21. According to the information displayed on the touch screen, the beverage making parameter of the beverage making assembly 20A can be controlled, for example, the rotational speed of the beverage making element 21 can be controlled. It is appreciated by those skilled in the art that the beverage making parameters, such as the stirring speed, of the beverage making assembly 20A can be controlled by the control system 232A depending on the difference in the raw material for the beverage production within the bottle body 10 and the need for the beverage. The control system 232A can control the driving unit 22 and control the rotational speed of the beverage making element 21 by the touch command received by the touch element 231A, thereby controlling the stirring speed.

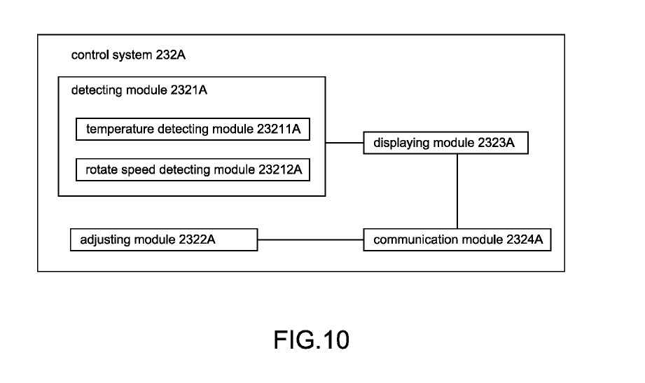

As shown in FIG. 10, the control system 232A includes a detecting module 2321A, an adjusting module 2322A and a displaying module 2323A. The detecting module 2321A is arranged to monitor the parameters of the beverage in the beverage bottle and the beverage making parameters, such as the temperature, concentration, viscosity of the beverage, and the speed at which the beverage is produced. The adjusting module 2322A is set to adjust the beverage making parameters. The detecting module 2321A is connected to the displaying module 2323A to display the parameters monitored by the detecting module 2321A. The displaying module 2323A may be connected to a display screen, such as the touch screen, to display the parameters monitored by the detecting module 2321A through the touch screen. Those skilled in the art can understand that the parameters monitored by the detecting module 2321A through the touch screen of the beverage bottle are merely illustrative of the present invention and are not limited thereto. The parameters monitored by the detecting module 2321A may also be displayed in other ways, for example, via a handset. According to this second preferred embodiment of the present invention, as shown in FIG. 10, the control system 232A further comprises a communication module 2324A so as to be able to be connected with an electronic device, and the parameters monitored by the detecting module 2321A can be controlled by the electronic device. The device is shown and the operating parameters of the beverage making element 21 can be adjusted by operating the electronic device. In particular, the communication module 2324A may connect the adjusting module 2322A to the electronic device so that the consumer can adjust the beverage making parameters by operating the electronic device. More specifically, the communication module 2324A cannot only connect the adjusting module 2322A to the electronic device so as to adjust the beverage production parameter by manipulating the electronic device, and the displaying module 2323A can be connected to the electronic device to display information about drinks and drinks through the electronic device.

It is to be noted that according to the second preferred embodiment of the present invention, the adjusting module 2322A is connected to the touch screen so that the beverage production parameter can be adjusted by manipulating the touch screen.

According to this second preferred embodiment of the present invention, the detecting module 2321A includes a temperature detecting module 23211A and a rotate speed detecting module 23212A to separately measure the temperature of the beverage of the bottle body 10 and the rotate speed of the beverage making element 21 monitor.

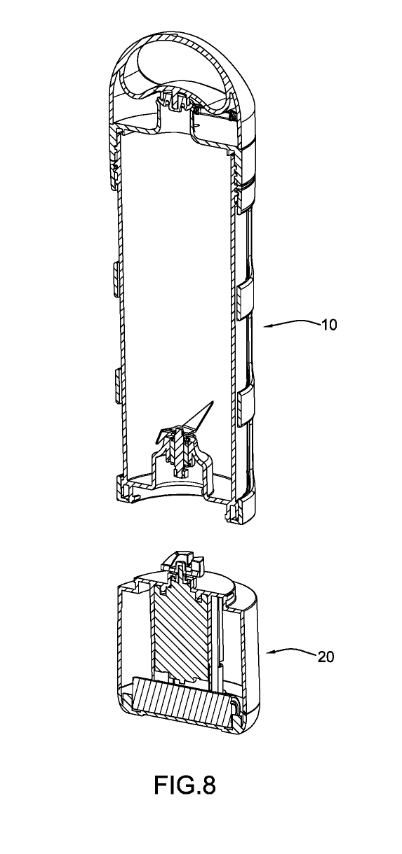

As shown in FIG. 8, the bottle body 10 is detachably connected to the beverage making assembly 20A. When the beverage making assembly 20A is detached from the bottle body 10, the beverage making element 21 of the beverage making assembly 20A can be held with the bottle body 10 and fixed to the bottle body 10. At this time, the cutters of the beverage making element 21 are held in the bottle body 10 and is not exposed to the outside to cause injury to the outer object or to be damaged by the outer object.

As shown in FIGS. 1 to 6, specifically, the present invention provides a beverage bottle, according to the preferred embodiments of the present invention, wherein the beverage bottle comprises a bottle body 10, a bottle lid 12 and a beverage making assembly 20, such as a cutting device, wherein the bottle body 10 has a side wall 111 and a bottle bottom 113 provided in the side wall 111 of the bottle body 10, wherein the cutting device 20 is provided in the bottle bottom 113 of the bottle body 10.

As shown in FIGS. 1 to 6, the cutting device 20 of the beverage bottle according to the preferred embodiments of the present invention includes a driving shaft 211, a cutter assembly 212 and a driving unit 22, such as a power unit. The driving shaft 211 defines a driven end 2111 and a driving end 2112. The power unit 22 includes an energy supplying element 221, such as a power module, and a driving element 222, such as a motor, wherein the motor 222 has a driving member 2221. The cutters of the cutter assembly 212 are respectively provided at the driven end 2111 of the driving shaft 21. The driving end 2112 of the driving shaft 211 is capable of being engaged with the driving member 2221 of the motor 222, so that the cutter assembly 212 of the cutting device 20 can be driven to rotate by the driving shaft 211 and the driving member 2221 of the motor 222 by the motor 222. It is understood that the cutter assembly 212 of the cutting device 20 of the present invention is capable of smashing pulps of fruits, such as orange, lemon, orange, grapefruit, apple, pear, peach and the like, to produce fruit juices. Further, the cutter assembly 212 of the cutting device 20 of the beverage bottle can also be used as a stirring mechanism to add beverages, such as coffee, milk, sweetener, sour agent, salted and the like, into the beverage bottle and/or condiments stir well.

As shown in FIGS. 3A, 5 and 6, the bottle bottom 113 of the bottle body 10 of the beverage bottle of the present invention forms a through hole 500, such as a mounting hole, wherein the driving shaft 211 of the cutting device 20 is rotatably provided in the mounting hole 500. As shown in FIGS. 3A, 5 and 6, preferably, the bottle bottom 113 of the bottle body 10 of the beverage bottle comprises a bottom wall 1131 extended from the side wall 111 of the bottle body 10 and a holding portion 1132 extended upwardly from the bottom wall 1131, wherein the holding portion 1131 forms the mounting hole 500. More preferably, the holding portion 1132 of the bottle bottom 113 of the bottle body 10 is capable of holding the driven end 2111 of the driving shaft 211 within the receiving cavity 100 of the bottle body 10 to ensure the cutter assembly 212 of the cutting device 20 to be retained within the receiving cavity 100 of the bottle body 10.

As shown in FIGS. 3A, 5 and 6, the side wall 111 of the bottle body 10 of the beverage bottle of the present invention has a lower end 1111 and a upper end 1112 extended upwardly from the lower end 1111, wherein the lower end 1111 of the side wall 111 of the bottle body 10 and the holding portion 1132 of the bottle bottom 113 of the bottle body 10 form a groove 101 provided therebetween. The upper end 1112 of the side wall 111 of the bottle body 10 forms the main cavity 102 of the receiving cavity 100 of the bottle body 10. The cutter assembly 212 of the cutting device 20 includes at least one upper cutter 2121 extended outwardly and upwardly from the driven end 2111 of the driving shaft 211 within the main cavity 102 and at least one lower cutter 2122 extended downwardly and outwardly from the driven end 2111 of the driving shaft 211. In other words, the lower end 1111 of the side wall 111 of the bottle body 10 and the bottle bottom 113 of the bottle body 10 form the groove 101 of the receiving cavity 100, and that the upper end 1112 of the side wall 111 of the bottle body 10 forms the main cavity 102 of the receiving cavity 100. The upper cutter 2121 of the cutter assembly 212 of the cutting device 20 is provided within the main cavity 102 of the receiving cavity 100 of the bottle body 10, and the lower cutter 2122 of the cutter assembly 212 is provided within the groove 101 of the receiving cavity 100. Preferably, the upper cutter 2121 and the lower cutter 2122 of the cutter assembly 212 are alternately and spacedly provided at the driven end 2111 of the driving shaft 211. As shown in FIGS. 3A and 5, the power module 221 of the cutting device 20 of the present invention is electrically connected to the motor 222 to supply power to the motor 222.

As shown in FIGS. 3A and 5, the power module 221 of the cutting device 20 includes at least one rechargeable battery 2211 and a wireless charging module 2212 electrically connected to the rechargeable battery 2211, wherein the wireless charging module 2212 may be used to charge the rechargeable battery 2211.

As shown in FIGS. 3A and 3B, the cutting device 20 further includes a control system 23, such as a control unit, wherein the control unit 23 includes a controlling module 231 connected electrically to the power module 221 and the motor 222, respectively, wherein the controlling module 231 is configured to be able to control the power module 221 to supply power to the motor 222. In other words, the controlling module 231 can control the rotation of the motor 222 by controlling the power module 221 to supply power for the motor 222. As shown in FIGS. 3A and 3B, the control unit 23 of the cutting device 20 further includes a communication module 232 operably connected to the controlling module 231, wherein the communication module 232 is configured to receive a control signal, such as a control signal of a phone, and transmits the control signal to the controlling module 231 so that the controlling module 231 can control the power supply of the power module 221 to the motor 222 in accordance with the control signal, so as to control the rotation of the motor 222. As shown in FIGS. 3A and 3B, the control unit 23 of the cutting device 20 further includes a display screen 233 connected electrically to the controlling module 231 for displaying the operating state of the cutting device 20, such as the rotate speed of the motor 222, the running time, and the like. Preferably, the display screen 233 is a touch screen.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A beverage bottle, comprising:
at least one bottle body; and
at least one beverage making assembly, wherein said bottle body provides a receiving cavity therein, wherein said beverage making assembly is extended into said receiving cavity to make a raw beverage material in said receiving cavity into a drink for drinking.

2. The beverage bottle, as recited in claim 1, wherein said beverage making assembly comprises at least one beverage making element and at least one driving element, wherein said driving element drives said beverage making element in such a manner that said beverage making element is capable of mixing one or more raw beverage materials received in said receiving cavity to prepare the drink for drinking.

3. The beverage bottle, as recited in claim 1, wherein said beverage making assembly comprises at least one beverage making element and at least one driving element, wherein said driving element drives said beverage making element in such a manner that said beverage making element is capable of smashing one or more raw beverage materials received in said receiving cavity to produce the drink for drinking.

4. The beverage bottle, as recited in claim 1, wherein said beverage making assembly comprises at least one beverage making element and at least one driving element, wherein said driving element drives said beverage making element in such a manner that said beverage making is capable of smashing and mixing one or more raw beverage materials received in said receiving cavity to prepare the drink for drinking.

5. The beverage bottle, as recited in claim 1, wherein said driving element comprises at least one energy supplying element and at least one driving element, wherein said energy supplying element provides energy to said driving element, and said driving element further drives said beverage making element, wherein said beverage making element is fixed to said bottle body to form a firm connecting structure.

6. The beverage bottle, as recited in claim 5, wherein said beverage making assembly is detachably connected to a bottle bottom of said beverage bottle so that said driving element of said beverage making assembly is able to be separated from said bottle body, wherein when said driving element is detached from said bottle body, said beverage making assembly is retained to be fixedly connected to said bottle body.

7. The beverage bottle, as recited in claim 6, wherein said bottle body has an opening and at least one side wall and comprises at least one bottle lid, wherein said side wall defines said receiving cavity in said bottle body, wherein said bottle lid is capable of closing said opening, wherein said bottle lid provides a handle hole.

8. The beverage bottle, as recited in claim 7, wherein said bottle lid comprises an opening cap and a drinking cap, wherein said opening cap is provided in said bottle body, wherein said opening cap has a drinking opening, wherein said drinking cap is used to close said drinking opening.

9. The beverage bottle, as recited in claim 8, wherein said beverage making element comprises a plurality of cutters which is secured within said receiving cavity.

10. The beverage bottle, as recited in claim 9, wherein said bottle body has a through hole provided at said bottle bottom of said bottle body, wherein said beverage making element further comprises at least one drive connecting member, wherein said cutters are extended respectively and outwardly from said drive connecting member, wherein said drive connecting member is extended into the through hole and closes the through hole, wherein said cutters are capable of being driven by said driving element to rotate in said receiving cavity.

11. A beverage bottle, comprising:
a bottle body having at least an opening;
a bottle lid arranged to cover said opening; and
a cutting device, wherein said bottle body has a side wall and a bottle bottom disposed at said side wall, wherein said cutting device is provided at said bottle bottom of said bottle body.

12. The beverage bottle, as recited in claim 11, wherein said bottle bottom has a through hole, wherein said cutting device comprises a driving shaft, a cutter assembly and a motor, wherein said driving shaft is rotatably provided in said through hole of said bottle bottom, wherein said motor has a driving member, wherein said driving shaft defines a driven end and a driving end, wherein said cutting cutters of said cutter assembly are respectively provided at said driven end of said driving shaft, and said driving end of said driving shaft is arranged to be engaged with said driving member of said motor so that said cutters of said cutting device are capable of being driven to rotate through said driving shaft and said driving member by said motor.

13. The beverage bottle, as recited in claim 12, wherein said bottle bottom of said beverage bottle comprises a bottom wall extending from said side wall of said bottle body and a holding portion extending upwardly from said bottom wall, wherein said holding portion is formed Said mounting hole wherein said holding portion of said bottle bottom is provided so as to be able to hold said driven end of said driving shaft in said receiving cavity of said bottle body.

14. The beverage bottle, as recited in claim 12, wherein said side wall of said bottle body has a lower end and a upper end extended upwardly from said lower end, wherein said bottle bottom of said bottle body comprises a bottom wall extended from said side wall and a holding portion extended upwardly from said bottom wall, wherein said holding portion forms said mounting hole, wherein said upper end of said side wall of said bottle body forms a main cavity of said receiving cavity of said bottle body, said lower end of said side wall and said holding portion of said bottle bottom of said bottle body form a groove therebetween, wherein said cutter assembly of said cutting device comprises at least one upper cutter extended upwardly and outwardly from said driven end of said driving shaft and at least one lower cutter extended downwardly and outwardly from said driven end of said driving shaft.

15. The beverage bottle, as recited in claim 13, wherein said side wall of said bottle body has a lower end and a upper end extending upwardly from said lower end, wherein said upper end of said side wall of said bottle body forms a main cavity of said receiving cavity of said bottle body, said lower end of said side wall and said holding portion of said bottle bottom of said bottle body forms a groove therebetween, wherein said cutter assembly of said cutting device comprises at least one upper cutter extended upwardly and outwardly from said driven end of said driving shaft and at least one lower cutter extended downwardly and outwardly from said driven end of said driving shaft.

16. The beverage bottle, as recited in claim 12, wherein said cutting device further comprises a power module connected electrically to said motor, wherein said power module comprises at least one rechargeable battery and a wireless charging module connected to said rechargeable battery, wherein said wireless charging module is used for charging said rechargeable battery.

17. The beverage bottle, as recited in claim 15, wherein said cutting device further comprises a power module connected electrically to said motor, wherein said power module comprises at least one rechargeable battery and a wireless charging module connected to said rechargeable battery, wherein said wireless charging module is used for charging said rechargeable battery.

18. The beverage bottle, as recited in claim 16, wherein said cutting device further comprises a controlling module connected respectively and electrically to said power module and said motor, wherein said controlling module is arranged to control said power module to supply power to said motor.

19. The beverage bottle, as recited in claim 17, wherein said cutting device further comprises a controlling module connected respectively and electrically to said power module and said motor, wherein said controlling module is arranged to control said power module to supply power to said motor.

20. The beverage bottle, as recited in claim 18, wherein said cutting device further comprises a communication module connected electrically to said controlling module, wherein said communication module is arranged to receive a control signal from a control terminal, and transmit said control signal to said controlling module so that said controlling module is capable of control ling said power module to supply power to said motor in accordance with said control signal.
